(19) United States
(12) Patent Application Publication
(10) Pub. No.: US 2023/0364727 A1
(43) Pub. Date: Nov. 16, 2023

(54) MACHINING METHOD FOR MANUFACTURING A DENTAL OBJECT

(71) Applicant: Ivoclar Vivadent AG, Schaan (LI)

(72) Inventors: Hannes Gurschler, Bludenz (AT); Christian Wellinger, Nüziders (AT); Andreas Gantioler, Bludenz (AT); Jonas Reinhardt, Igis (CH)

(21) Appl. No.: 18/314,045

(22) Filed: May 8, 2023

(30) Foreign Application Priority Data
May 10, 2022 (EP) 22172465.1

(51) Int. Cl. B23Q 15/06; B23Q 15/12; B23Q 17/09

(52) U.S. Cl. CPC B23Q 15/06; B23Q 15/12; B23Q 17/0952

(57) ABSTRACT

A machining method including the steps of providing (S101) a data set (101) for the milling process in which at least one process parameter (103) for machining a workpiece (105) is specified; simulating (S102) a machining force on the workpiece (105) based on the data set; and adjusting (S103) the process parameter (103) for machining until a predetermined maximum value for the machining force is reached or a predetermined minimum value is maintained.

### CROSS-REFERENCE TO RELATED APPLICATIONS

This application claims priority to European Patent Application No. 22172465.1 filed on May 10, 2022, the disclosure of which is incorporated herein by reference in its entirety.

### TECHNICAL FIELD

The present invention relates to a machining method for manufacturing a dental object, a computer program for the machining method, and a machining apparatus for manufacturing a workpiece.

### BACKGROUND

Currently, milling templates, which describe toolpaths and the associated process parameters for a milling process, such as a feed rate or a spindle speed, are designed for a worst-case scenario. In reality, this occurs with a probability of less than 10 percent. Therefore, efficiency improvements of more than 90 percent can be realized in these processes. Current milling templates are therefore slow.

Approaches to simulate machining via models are resource-intensive. In addition, a dynamic behavior of the apparatus and a control are not considered in these models. Therefore, they are not suitable for widespread use and there is no possibility to determine occurring machining forces.

US 20210138589 and 20200041986 are directed to machining methods and/or systems and are hereby incorporated by reference in their entirety.

### SUMMARY

It is the object of the present invention to carry out a machining method more efficiently.

This technical object is solved by subject-matter according to the independent claims. Technically advantageous embodiments are subject of the dependent claims, the description and the drawings.

According to a first aspect, this technical object is solved by a machining method for manufacturing a dental object, comprising the steps of providing a data set for the milling process in which at least one process parameter for machining a workpiece is specified; simulating a machining force on the workpiece based on the data set; and adjusting the process parameter for the machining until a predetermined maximum value for the machining force is reached or a predefined minimum value is maintained. The vector machining force can be simulated in one, two or three spatial directions. The machining method achieves the technical advantage that the workpiece can be produced faster, more efficiently and more robustly. In addition, longer tool life and less wear on the machining apparatus are achieved.

This allows work areas to be identified before the machining apparatus starts machining. A machining file can be optimally designed for efficiency so that a quality, a machining speed and a wear can be optimized. In addition, a manufacturing accuracy and a surface quality of the workpiece can be optimized. Peak forces during machining can be avoided. This protects a milling spindle, a tool and the entire machining apparatus. In addition, smaller and less expensive machining apparatuses can be used, which have the same performance as large conventional apparatuses.

In a technically advantageous embodiment of the machining method, the adjusted process parameters are stored in at least one data set. In general, the process parameters can also be stored in several data sets. This provides, for example, the technical advantage that the process parameters can be transferred easily and together.

In a further technically advantageous embodiment of the machining method, the machining force is simulated on the basis of a digital twin of the machining apparatus and/or a workpiece. This achieves, for example, the technical advantage that the machining force can be calculated accurately.

In a further technically advantageous embodiment of the machining method, the machining force is simulated on the basis of toolpaths for machining the workpiece. Here, the apparatus dynamics can be involved or considered. This has the technical advantage, for example, that the machining force can be calculated for each movement of the milling head.

In a further technically advantageous embodiment of the machining method, the data for the toolpaths are specified in the data set. This has the technical advantage, for example, that the data for toolpaths and the process parameters can be transmitted together. The transfer and the start of the machining method can be performed before the simulation is finished.

In a further technically advantageous embodiment of the machining method, the toolpaths are adjusted until a predetermined maximum value for the machining force is reached and/or a predetermined minimum value is maintained. This achieves, for example, the technical advantage of obtaining toolpaths that can be machined quickly.

In a further technically advantageous embodiment of the machining method, the machining force on the workpiece is calculated on the basis of an acceleration, a feed rate and/or a machining volume per time. This achieves the technical advantage, for example, that the machining force can be calculated precisely.

In a further technically advantageous embodiment of the machining method, the simulation is performed on the basis of a linear relationship between the process parameter and the machining force. This achieves, for example, the technical advantage that the simulation can be calculated quickly and with few steps.

In a further technically advantageous embodiment of the machining method, the simulation of the machining force is performed during a machining of the workpiece. This achieves, for example, the technical advantage that the tool can be milled in real time with improved parameters.

In a further technically advantageous embodiment of the machining method, a workpiece is produced on the basis of the modified process parameters and/or toolpaths. This achieves, for example, the technical advantage that the workpiece can be manufactured efficiently.

In a further technically advantageous embodiment of the machining method, a spindle current is measured and/or a machining energy is determined during machining of the workpiece. The spindle current correlates with the machining force. Therefore, the control can be derived from the spindle current. This also achieves, for example, the technical advantage that the machining force can be determined precisely.

In a further technically advantageous embodiment of the machining method, machining is stopped when the spindle current and/or the machining energy exceeds a predetermined value. This achieves, for example, the technical advantage of preventing damage to the workpiece and the machining apparatus.

In a further technically advantageous embodiment of the machining method, a feed rate is slowed down or accelerated if the spindle current and/or the machining energy and/or machining force exceeds or falls below a predetermined value, respectively. This achieves, for example, the technical advantage that the machining of the workpiece can be optimized.

According to a second aspect, this technical object is solved by a computer program comprising instructions which, when the program is executed by a computer, cause the computer to execute the machining method according to the first aspect.

According to a third aspect, this technical object is solved by a machining apparatus for manufacturing a dental object with a computer program according to the second aspect.

### BRIEF DESCRIPTION OF THE DRAWINGS

Examples of embodiments of the invention are shown in the drawings and are described in more detail below.

The figures show:

FIG. 1 a block diagram of the machining method;

FIG. 2 a diagram of the occurring and simulated machining forces as a function of time;

FIG. 3 an enlarged diagram of the occurring and simulated machining forces as a function of time;

FIG. 4 a perspective view of a workpiece in a machining apparatus; and

FIG. 5 a further perspective view of the workpiece.

### DETAILED DESCRIPTION

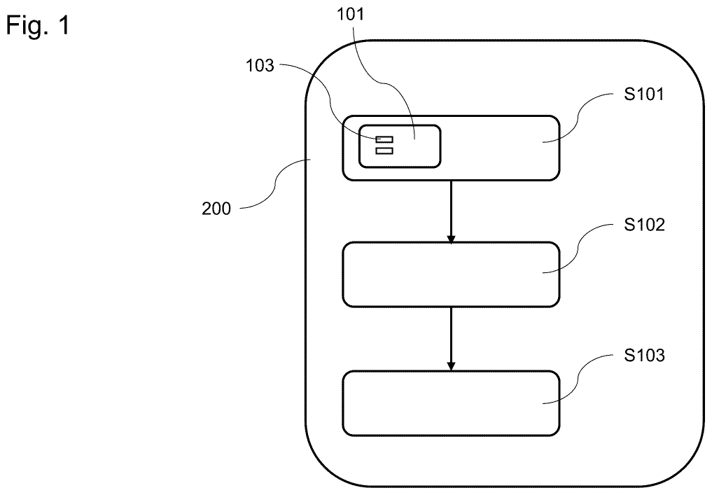

FIG. 1 shows a block diagram of the machining method for manufacturing a dental object from a workpiece. The machining method is a manufacturing process that involves turning, drilling, milling and grinding. For example, the dental object is a crown, a bridge, a veneer, an abutment, an inlay, an onlay, a splint, or a partial or full denture. In general, the dental object can be any object in the dental area that is to be produced as part of a dental treatment.

In step S101, a data set 101 for the machining method is provided, in which at least one process parameter 103 for machining a workpiece 105 is specified. The data set 101 may be formed by a numerical control file (NC file). The process parameters may be, for example, a feed rate, an infeed, a path distance, and/or a spindle speed.

For example, the machining energy is calculated based on several factors, such as a milling volume per time, a material dependency, a contact area, a time, a spindle speed and machining force.

$$u = \frac{F \cdot {v}_{c}}{{a}_{p} \cdot {a}_{e} \cdot {v}_{f}}$$

Then, in step S102, a machining force on a workpiece 105 is simulated based on the data set. Then, in step S103, the process parameter 103 for machining is adjusted until a predetermined maximum value for the machining force is reached or a prespecified minimum value is maintained. The workpiece can then be manufactured with the adjusted process parameters.

The machining method may be performed on a machining apparatus 200 that machines the workpiece using a metal machining method. By means of rotating machining tools, for example, the machining apparatus removes material from the workpiece 105 in a machining manner to bring it into the desired shape.

For this purpose, the machining apparatus 200 may comprise a computer comprising a processor for executing a corresponding computer program and a digital memory for storing the computer program and other data. Through the computer program, steps S101, S102, and S103 of the machining method may be implemented. Then, the workpiece 105 can be milled based on the adjusted process parameters. For example, the workpiece 105 is a dental object, such as a crown, bridge, veneer, abutment, inlay, or onlay.

The occurring force F can be calculated from the following formula:

$$F = \frac{u \cdot {a}_{p} \cdot {v}_{f} \cdot {a}_{e}}{{v}_{c}}$$

The machining energy u be calculated from the following formula:

$$u = \frac{F \cdot {v}_{c}}{{a}_{p} \cdot {a}_{e} \cdot {v}_{f}}$$

Here u is the loop energy in J/mm³, F is the machining force as a vector in space in N, v_{c} is the machining speed in m/min, aₚ is the infeed in Z direction in mm, aₑ is the infeed in X direction in mm and V_{f} is the feed rate in mm/min. Based on these formulas, a prediction of the occurring machining force can be performed and adaptation of the process parameters can be calculated.

$$F = \frac{12 [ \frac{J}{{mm}^{3}} ] \cdot 0.02 [ mm ] \cdot 1500 [ \frac{mm}{min} ] \cdot 13 [ mm ]}{471.238 [ \frac{mm}{min} ]} = 9.52 [ N ]$$

$${v}_{f} = \frac{25 [ N ] \cdot 471.238 [ \frac{mm}{min} ]}{12 [ \frac{J}{{mm}^{3}} ] \cdot 0.02 [ mm ] \cdot 13 [ mm ]} = 3775.9 [ \frac{mm}{min} ]$$

Through the machining method, the process parameters can be extracted and processed from a CAM file, an NC file, a digital twin, and/or the apparatus at any point in the machining process so that a prediction of the machining conditions that will occur can be made and the process parameters can be changed to an optimum.

Only one parameter or all parameters can be adjusted at a time to regulate the load. In general, the adjustment of all parameters is possible here.

The milling process can be run in the optimum range, i.e., as fast as possible and with the least wear. The adjustment can be done sensorless and/or by measuring the power of the machining spindle, in which a current sensor is integrated. The milling process is pre-optimized in advance for a specific design and is then corrected with the current state of the machining apparatus.

This information can be extracted from a CAM or NC file for any point in the machining method. It is also possible to simulate the milling process using a digital twin. This simulates the dynamic parameters, such as accelerations or feeds, at each point in time and predicts the resulting machining state. The simulation of the digital twin can be carried out temporally not only before the machining method but can also be considered during the machining method.

This makes it possible to optimize the NC file in advance for minimum machining time, minimum tool wear, maximum accuracy and/or maximum surface quality. This can be done in the CAM software and saved in the NC file. This involves communication between the CAM software and the machining apparatus (CNC—Computerized Numerical Control). This can be realized in real time. In this process, the CAM software sends data packets to the machining apparatus, which can be adjusted accordingly. The adjustment is calculated in the CAM software and implemented in the machining apparatus.

The same algorithm can run on the machining apparatus, but additionally trained with the spindle current as input variable. With the current values on the apparatus and the spindle current, the model can then predict the currently occurring force.

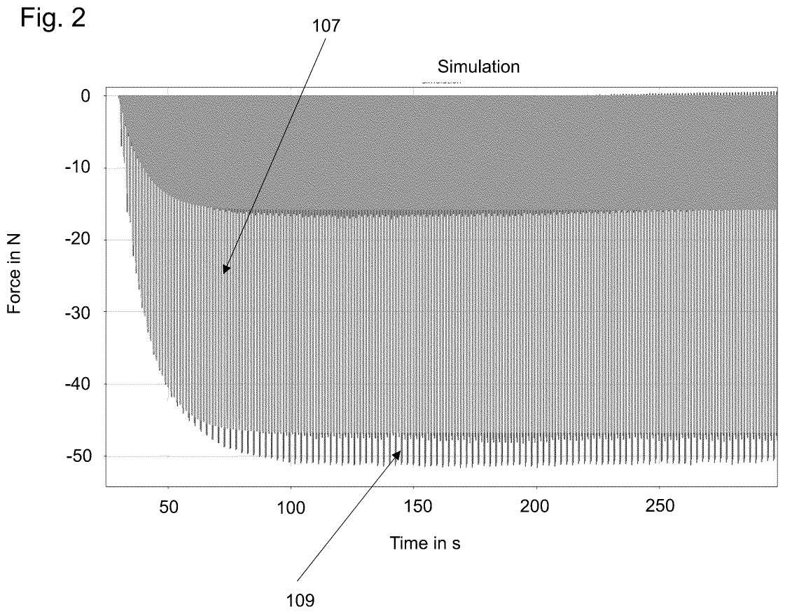

FIG. 2 shows a diagram of the occurring and simulated machining forces as a function of time for a large number of toolpaths. Via the process parameters, it is possible to predict the occurring machining forces based on the simulation.

The measured machining force is shown as line 109. Line 107 shows the machining force predicted by the algorithm. A linear model (linear regression) was trained, with which the machining force can be predicted via the process parameters with a low computational effort.

The same algorithm can run on the machining apparatus, but additionally trained with the spindle current as input variable. With the current values on the machining apparatus and the spindle current, the model can then predict the force that is currently occurring. This allows unplanned problems to be detected and acted upon accordingly. Thus, an optimal milling-grinding process can be guaranteed at any time.

In this case, a small and unbalanced data set is used to train the model. The prediction is accurate to 89 to 90%.

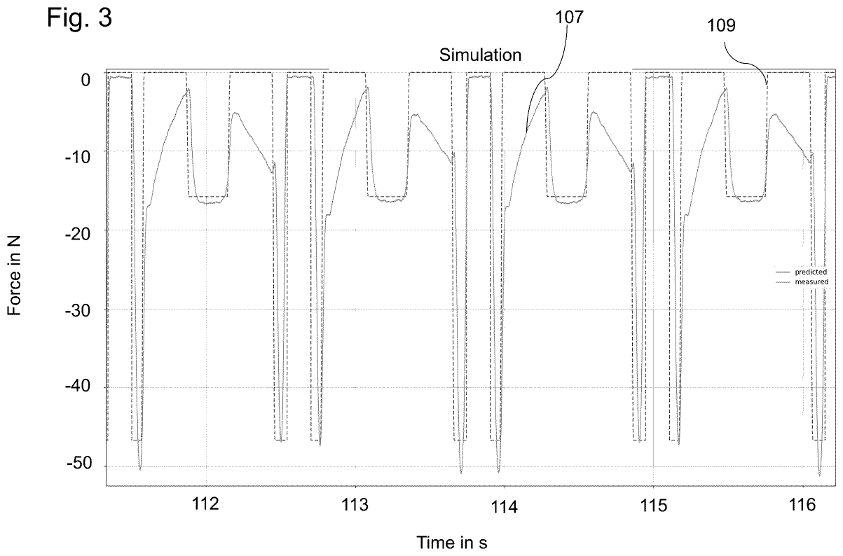

FIG. 3 shows an enlarged diagram of the occurring and simulated machining forces as a function of time for a few toolpaths. The deviations between the simulated machining force 107 (dashed line) and the measured force 109 (solid line) of the toolpaths are small.

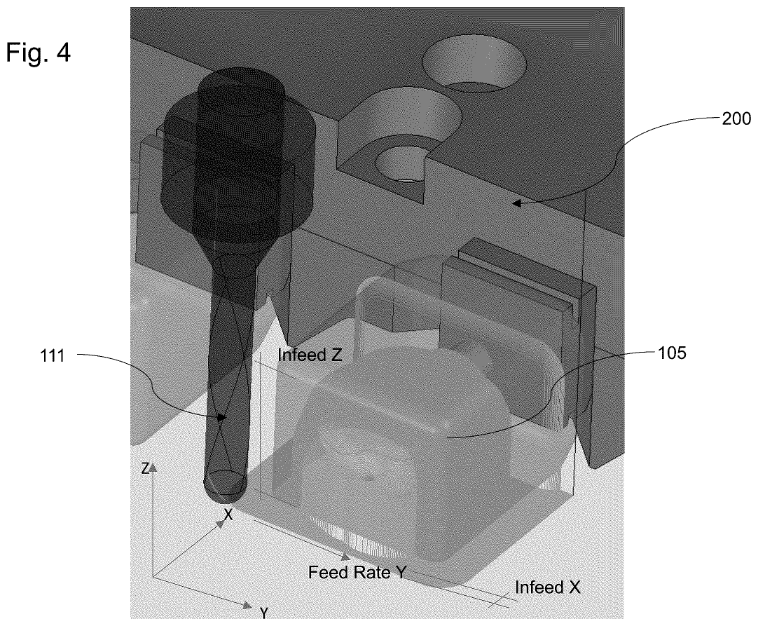

FIG. 4 shows a perspective view of a workpiece 105 in a machining apparatus 200 with a milling head 111. In addition, an associated coordinate system and the infeed in the x and z directions and the feed rate in the y direction are shown.

For example, the workpiece 105 is manufactured with the process parameters of a spindle speed of 50,000 rpm, a path spacing of 0.1 mm and a feed rate of 2500 mm/min. The objective is to ensure that a constant machining force of 50 N is applied throughout the machining method. Machining is performed, for example, by an AI milling operation.

There is a direct relationship between process parameters and machining force. The relationship is largely linear, but each parameter has different influences on the machining condition that occurs. These vary constantly during a milling process and are never constant.

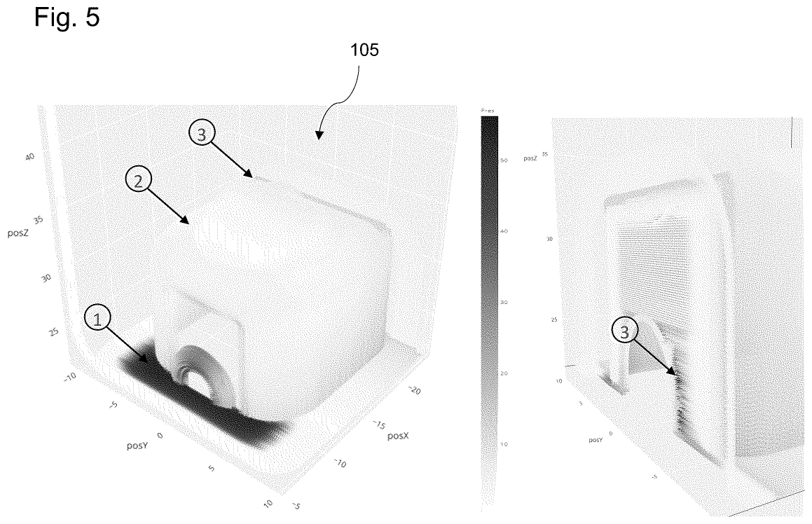

FIG. 5 shows a further perspective view of the workpiece 105. During machining, for example, three different situations 1, 2, and 3 may be present.

Situation 1:

In this situation, the processing power is high at this time:

$$F = \frac{12 [ \frac{J}{{mm}^{3}} ] \cdot 0 \text{.1} [ mm ] \cdot 2500 [ \frac{mm}{min} ] \cdot 13 [ mm ]}{471.238 [ \frac{mm}{min} ]} = 82.76 [ N ]$$

$${v}_{f} = \frac{50 [ N ] \cdot 471.238 [ \frac{mm}{min} ]}{12 [ \frac{J}{{mm}^{3}} ] \cdot 0.1 [ mm ] \cdot 13 [ mm ]} = 1510.38 [ \frac{mm}{min} ]$$

The load of 83 N is above a specified maximum value. Therefore, the process parameters are selected to reduce the load to 50 N. One possibility is to adjust the process parameter for the feed. Releasing this process parameter and inserting the desired load will result in an adjusted new feed rate that will be used to apparatus in that range to achieve the desired 50 N force. The process parameter for the feed is reduced from 2500 mm/min to 1510 mm/min.

Situation 2:

In this situation, the processing power is low at this time:

$$F = \frac{12 [ \frac{J}{{mm}^{3}} ] \cdot 0 \text{.1} [ mm ] \cdot 2500 [ \frac{mm}{min} ] \cdot 4 [ mm ]}{471.238 [ \frac{mm}{min} ]} = 25.46 [ N ]$$

$${v}_{f} = \frac{50 [ N ] \cdot 471.238 [ \frac{mm}{min} ]}{12 [ \frac{J}{{mm}^{3}} ] \cdot 0.1 [ mm ] \cdot 4 [ mm ]} = 4908.73 [ \frac{mm}{min} ]$$

The load of 25 N is below a specified minimum value. Therefore, the process parameters are selected to increase the load to 50 N. One possibility is to adjust the process parameter for the feed. If this process parameter is left blank and the desired load is inserted, the result will be an adjusted new feed rate that will be used to apparatus in this range to achieve the desired 50 N force. The process parameter for the feed is increased from 2500 mm/min to 4908 mm/min.

Situation 3:

In this situation, the processing power is high again at this time:

$$F = \frac{12 [ \frac{J}{{mm}^{3}} ] \cdot 0 \text{.1} [ mm ] \cdot 2500 [ \frac{mm}{min} ] \cdot 11 [ mm ]}{471.238 [ \frac{mm}{min} ]} = 70 [ N ]$$

$${v}_{f} = \frac{50 [ N ] \cdot 471.238 [ \frac{mm}{min} ]}{12 [ \frac{J}{{mm}^{3}} ] \cdot 0.1 [ mm ] \cdot 11 [ mm ]} = 1784.99 [ \frac{mm}{min} ]$$

The load of 70 N is again above a specified maximum value. Therefore, the process parameters are selected so that the load is reduced to 50 N. One possibility is to adjust the process parameter for the feed. If this process parameter is left blank and the desired load is inserted, the result is an adjusted new feed rate at which machining is performed in this range to achieve the desired 50 N force. The process parameter for the feed is reduced from 2500 mm/min to 1785 mm/min.

In these examples, the feed rate is used as the variable to be controlled. However, other process parameters, such as path spacing and/or spindle speed, can also be changed according to the same principle in order to achieve the desired load. In this case, the control can be stepless. For this purpose, a milling path can be changed in the CAM software. The adjustment is made by means of a simulation in the CAM software or information in the CAM software for the path calculation. The deeper a milling drill penetrates into the workpiece 105, the higher the machining force.

The analysis can be performed on the basis of vectorial machining forces, a one-dimensional machining force or a spindle load. A vectorial force is a force with magnitude and spatial direction. In contrast, the spindle load is a scalar quantity.

An artificial intelligence-based algorithm can predict various loads that are not covered by an analytical solution. For example, when a tool rises out of or penetrates the material, or during a force buildup at the beginning of the machining job.

In this way, it is possible to optimize the machining of the workpiece 105 for maximum efficiency without high computational effort and additional costs. The machining force that occurs can be predicted with the aid of a self-learning algorithm (apparatus learning algorithm) based on the process parameters and the material of the workpiece 105.

In some embodiments, a data processing system may include one or more central processing units (CPU) or processors coupled to one or more user input/output (I/O) devices and memory devices. Examples of I/O devices may include, but are not limited to, keyboards, displays, monitors, touch screens, printers, electronic pointing devices such as mice, trackballs, styluses, touch pads, or the like. Examples of memory devices may include, but are not limited to, hard drives (HDs), magnetic disk drives, optical disk drives, magnetic cassettes, tape drives, flash memory cards, random access memories (RAMs), read-only memories (ROMs), smart cards, etc. A data processing system can be coupled to a display, information device and various peripheral devices such as printers, plotters, speakers, etc. through I/O devices. A data processing system may also be coupled to external computers or other devices through network interface, wireless transceiver, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, and/or HD), hardware circuitry or the like, or any combination thereof. Within this disclosure, the term “computer-readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer-readable medium (for example, a disk, CD-ROM, a memory, etc.). Alternatively or additionally, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HyperText Markup Language (HTML), Python, or any other programming or scripting code. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components, and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

All features explained and shown in connection with individual embodiments of the invention may be provided in different combinations in the subject-matter of the invention to simultaneously realize their beneficial effects.

All method steps can be implemented by devices which are adapted for executing the respective method step. All functions that are executed by the objective features can be a method step of a method.

The scope of protection of the present invention is given by the claims and is not limited by the features explained in the description or shown in the figures.

Reference List

101 Data set

103 Process parameters

105 Workpiece

107 Simulated force of the toolpaths

109 Measured force of the toolpaths

111 Milling head

200 Machining apparatus

1. A machining method for manufacturing a dental object, comprising
providing (S101) a data set (101) for the milling process, in which at least one process parameter (103) for the machining of a workpiece (105) is specified;
simulating (S102) a machining force on the workpiece (105) based on the data set; and
adjusting (S103) the at least one process parameter (103) for machining until a preset maximum value for the machining force is reached or a preset minimum value is maintained.

2. The machining method according to claim 1,
wherein the adjusted at least one process parameter is stored in at least one data set (101).

3. The machining method according to claim 1,
wherein the machining force is simulated based on a digital twin of a machining apparatus (200) and/or a workpiece (105).

4. The machining method according to claim 1,
wherein the machining force is simulated based on toolpaths for machining the workpiece (105).

5. The machining method according to claim 4,
wherein the data for the toolpaths are specified in the data set.

6. The machining method according to claim 4,
wherein the toolpaths are adjusted until a predetermined maximum value for the machining force is reached and/or a predetermined minimum value is maintained.

7. The machining method according to claim 1,
wherein the machining force on the workpiece (105) is calculated based on an acceleration, a feed rate and/or a machining volume per time.

8. The machining method according to claim 1,
wherein the simulation is performed based on a linear relationship between the at least one process parameter and the machining force.

9. The machining method according to claim 1,
wherein simulating the machining force is performed during a machining of the workpiece (105).

10. The machining method according to claim 1,
wherein the workpiece (105) is produced based on the modified process parameters and/or toolpaths.

11. The machining method according to claim 10,
wherein a spindle current is measured and/or a machining energy is determined during machining of the workpiece (105).

12. The machining method according to claim 11,
wherein machining is stopped when the spindle current and/or the machining energy exceeds a predetermined value.

13. The machining method according to claim 11,
wherein a feed is slowed down or accelerated when the spindle current and/or the machining energy and/or the machining force exceeds or falls below a predetermined value.

14. A computer program product comprising program code which is stored on a non-transitory machine-readable medium, the machine-readable medium comprising computer instructions executable by a processor, which computer instructions cause the processor to perform the method as claimed in claim 1.

15. A machining apparatus (200) for manufacturing a dental object with a computer program according to claim 14.
